(19) United States
(12) Patent Application Publication
(10) Pub. No.: US 2009/0030797 A1
(43) Pub. Date: Jan. 29, 2009

(54) Method and apparatus for generating and transmitting an ideal order offer

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/217,810

(22) Filed: Jul. 9, 2008

Related U.S. Application Data
(63) Continuation-in-part of application No. 12/151,038, filed on May 2, 2008.
Application No. 12/151,038 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00

(52) U.S. Cl. 705/14; 705/26

(57) ABSTRACT

A system for generating and transmitting an ideal order offer, including: an interface element for at least one specially programmed general-purpose computer; a memory unit for the computer; and an offer element, in a processor for the computer. The offer element is for: receiving, using the interface element, an order from a customer, the order including at least one item or at least one service offered by a business entity; generating at least one ideal order offer using at least one of a first set of rules and a first artificial intelligence program stored in a memory unit for the computer, the at least one ideal order offer including at least one item or service not included in the order or an incentive not associated with the order; and transmitting, using the interface element, the order and the at least one ideal order for presentation to the customer.

### CROSS-REFERENCE TO RELATED APPLICATIONS

This is a continuation-in-part patent application under 35 USC 120 of U.S. patent application Ser. No. 12/151,038, filed May 2, 2008 and entitled “Method and Apparatus for Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for the generation and transmission of an ideal offer using one or both of at least one rule or an artificial intelligence program.

### BACKGROUND OF THE INVENTION

It is known for a business location, such as a restaurant or retail location to have cashiers or other personnel make suggestive sell offers to customers. Unfortunately, such offers are rarely automated, and, if the offers are automated, the offer only prompt the cashier. Further, only rudimentary logic is used for the determining of which item to suggestively sell to any particular customer. Although automated suggestive selling is more common when ordering products online, via the Internet, such systems generally are able to only provide generic suggestive selling options, for example, use of so-called “collaborative filters” and other similar methods. Therefore, known suggestive selling in responses to an order does not necessarily optimize parameters associated with a business entity fulfilling the order.

Thus, there is a long-felt need to provide a system and a method to intelligently and automatically respond to an order placed by a customer in a manner that optimizes parameters associated with a business entity fulfilling the order while increasing acceptability of such optimization to the customer placing the order.

### SUMMARY OF THE INVENTION

The invention broadly comprises a system for generating and transmitting an ideal order offer, including: an interface element for at least one specially programmed general-purpose computer; a memory unit for the at least one specially programmed general-purpose computer; and an offer element, in a processor for the at least one specially programmed general-purpose computer. The offer element is for: receiving, using the interface element, an order from a customer, the order including at least one item or at least one service offered by a first business entity; generating at least one ideal order offer using at least one of a first set of rules and a first artificial intelligence program stored in a memory unit for the at least one specially programmed general-purpose computer, the at least one ideal order offer including at least one item or service not included in the order or an incentive not associated with the order; and transmitting, using the interface element, the order and the at least one ideal order for presentation to the customer.

In a first embodiment, the offer element is for selecting a transaction history, stored in the memory unit, for the customer and generating the at least one ideal order offer includes generating the at least one ideal order offer using the transaction history. In a second embodiment, using the transaction history includes identifying a first item or service not included in the history or identifying a second item or service ordered by the customer at less than a predetermined frequency and generating the at least one ideal order offer comprises including, in the at least one ideal order offer, the first or second item or service. In a third embodiment, using the transaction history includes identifying an incentive previously presented to the customer and generating the at least one ideal order offer includes: modifying the incentive or generating a new incentive different from the incentive; and including, in the at least one ideal order offer, the modified incentive or the new incentive. In a third embodiment, the offer element is for evaluating the order to determine a number of other customers with the customer and the at least one item or service not included in the at least one regular order offer includes a number of said at least one item or service, respectively, equal to the number of the other customers.

In a fourth embodiment, the system includes a wireless communications device (WCD) associated with the customer, the offer element is for receiving, via a wireless communications network, the order from the WCD, and transmitting the at least one ideal order offer includes transmitting the at least one ideal order offer to the wireless communications network for transmission to the WCD. In a fifth embodiment, the system includes a WCD, associated with the customer, with a memory unit and a processor, the WCD for storing at least one second rule in a memory element for the WCD, transmitting the at least one ideal order offer includes transmitting the at least one ideal order offer to a wireless communications network for transmission to the WCD, and processor in the WCD is for executing the at least one ideal order offer according to the at least one second rule.

In a sixth embodiment, the offer element is for: receiving, using the interface element, at least one second rule from a WCD associated with the customer, or from a general-purpose computer associated with a second business entity; storing the at least one second rule in the memory unit; and modifying the at least one ideal order offer using the at least one second rule and transmitting the at least one ideal offer includes transmitting the modified at least one ideal offer. In a seventh embodiment, the offer element is for selecting at least one regular order stored in the memory unit, the at least regular order placed by the customer at a previous time with the first business entity and generating the at least one ideal order offer includes using the at least one regular order.

In an eighth embodiment, the order from the customer includes a request to initiate at least one regular order associated with the customer, the at least one regular order stored in the memory unit, generating the at least one ideal order offer includes using the at least one regular order, and transmitting the order and the at least one ideal order for presentation to the customer includes transmitting the at least one regular order. In a ninth embodiment, generating at least one ideal order offer includes modifying the order to include the at least one item or service not included in the order or to include an incentive regarding the at least one item or at least one service offered by the first business entity and transmitting the order and the at least one ideal order for presentation to the customer includes transmitting only the modified order to the customer. In a tenth embodiment, the offer element is for storing in the memory unit, using the processor, information regarding the historical acceptance of offers and modifying the first set of rules according to the information regarding the historical acceptance of offers.

The invention also broadly comprises a method for generating and transmitting an ideal order offer.

It is a general object of the present invention to provide.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD);

FIG. 3 is a schematic block diagram of a present invention system for generating and transmitting an ideal order offer; and,

FIG. 4 is a flow chart of a present invention method for generating and transmitting an ideal order offer.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

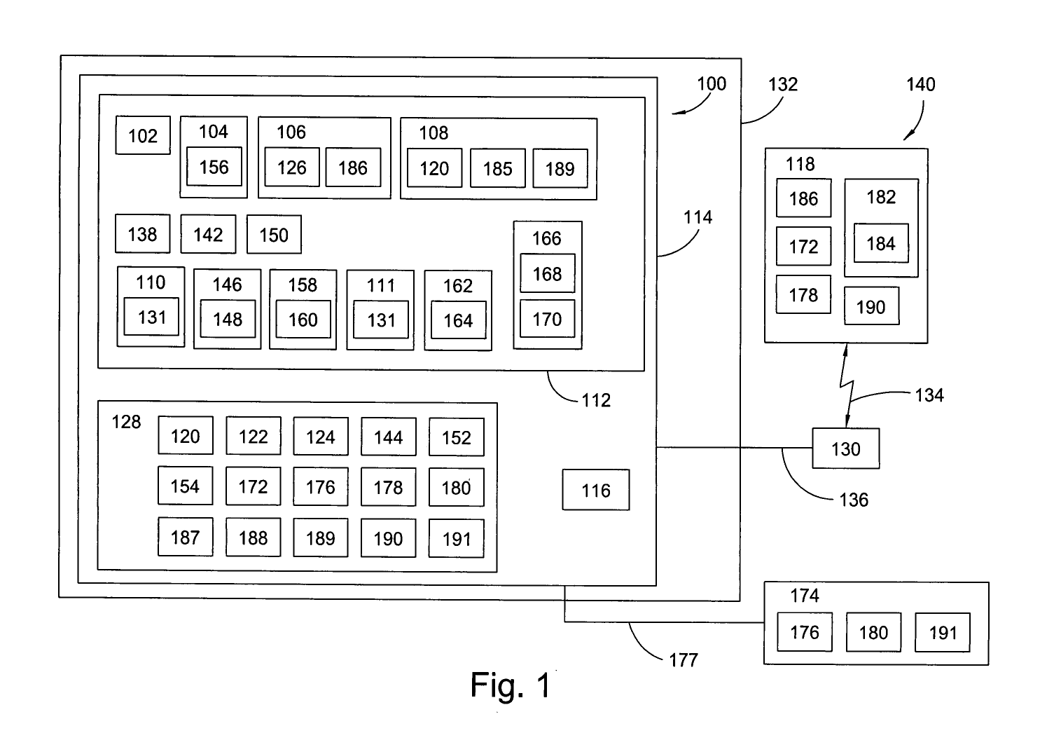

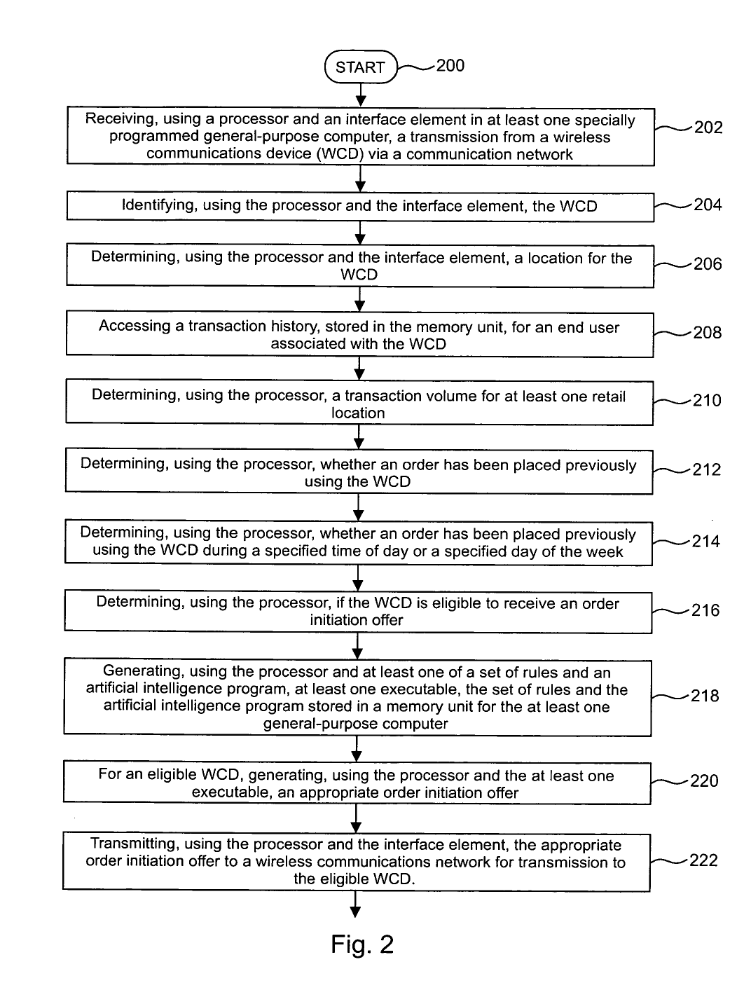

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

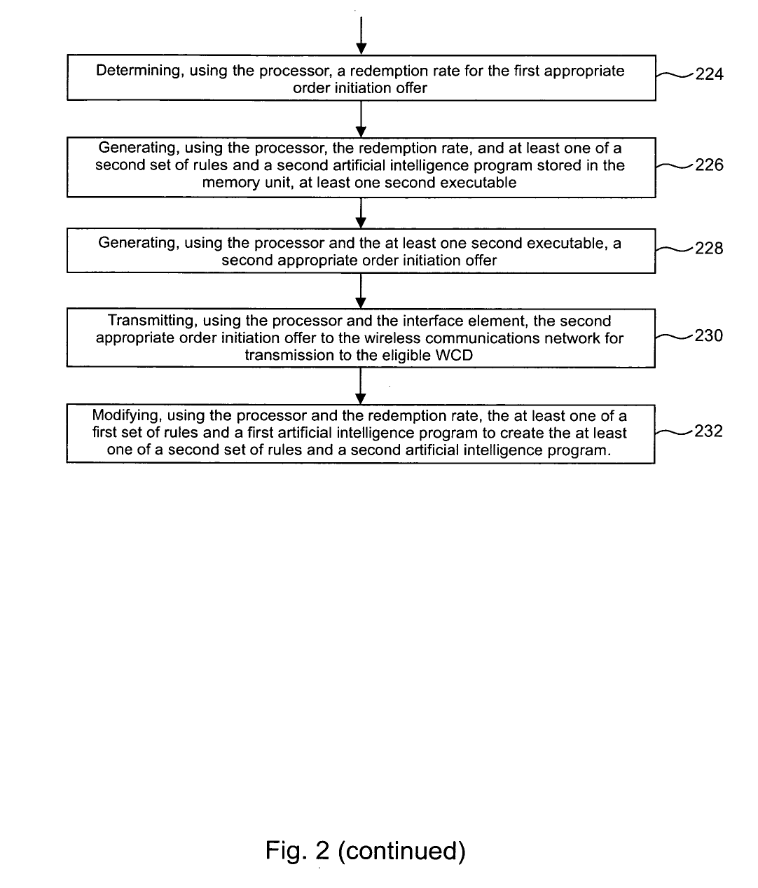

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

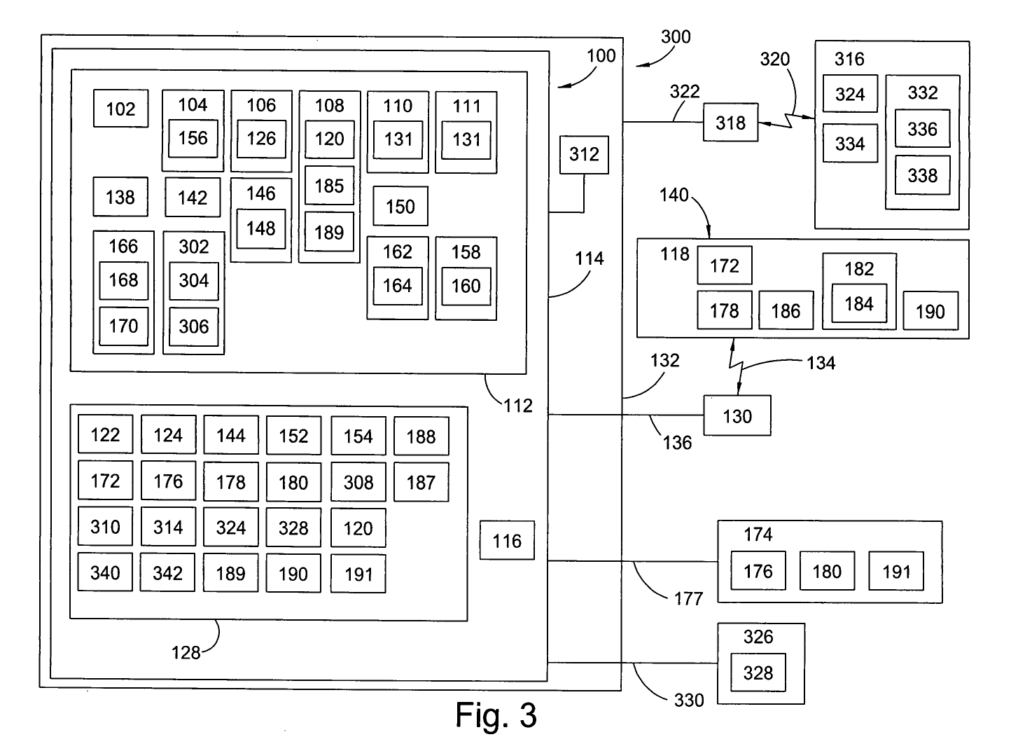

FIG. 3 is a schematic block diagram of present invention system 300 for generating and transmitting an ideal order offer. System 300 includes offer element 302, in processor 112. The offer element is for, that is, the offer element is arranged to, receiving, using the interface element, order 304 from a customer (not shown), the order including at least one item or at least one service offered by the business entity associated with location 132, hereafter called the first business entity. The offer element also generates at least one ideal order offer 306 using at least one of set of rules 308 and artificial intelligence program 310 stored in the memory unit. Alternately stated, element 302 and any other elements described as being in the processor are functions of the processor or are functions carried out by the processor. The at least one ideal order offer includes at least one item or service not included in the order or an incentive not associated with the order. Further, the offer element transmits, using the interface element, order 304 and offer 306 for presentation to the customer. The customer is given the option of selecting order 304 or replacing order 304 with the items or services included in offer 306. Offer 304 can include an incentive as well as an item or service offered by the first business entity. For example, the incentive can be a discount on the item or service.

In general, ideal offer 306 is directed to reaching one or more goals established by the first business entity or optimizing one or more parameters associated with operations of the first business entity. That is, generating an ideal order offer includes making a selection of one or more choices from among two or more choices that yields the best and/or optimized outcome or yields. Ideal can mean optimizing or maximizing revenues, profits, item counts, average check, market basket contents, marketing offer acceptance, store visitation or other frequency measures, and/or improving or optimizing speed of service, inventory levels, turns, yield, waste, and/or enhancing or optimizing customer loyalty and/or use of kiosks or internet or other POS devices or self service devices, and/or use of off peak or other coupons and/or acceptance of Upsell or other marketing offers, and/or reduction or optimization of any customer or cashier or any other person's gaming, fishing, or any other undesirable action or activities and/or failures to act when desired, and/or minimizing or optimizing any dilution or diversion of sales, profits, average check, and/or minimizing or optimizing use of discounts and other promotions so as to maximize or optimize any of the foregoing desired actions, outcomes or other desired benefits, and/or any combination of minimizing undesired results while maximizing or optimizing any one or more of any desired results. In addition to methods that may be disclosed herein, methods to provide the selection of an ideal offer are disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices;” and commonly-owned U.S. patent application Ser. No. 12/151,038, filed May 2, 2008 and entitled “Method and Apparatus for Generating and Transmitting an Order Initiation Offer to a Wireless Communications Device.”

In one embodiment, the discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation of offer 306, in particular, to the selection of items, services, or incentives to be included in the offer. In another embodiment, the discussion of the generation of an offer as disclosed by commonly-owned U.S. patent application Ser. No. 12/151,038, filed May 2, 2008 and entitled “Method and Apparatus for Generating and Transmitting an Order Initiation Offer to a Wireless Communications Device” is applicable to the generation of offer 306, in particular, to the selection of items, services, or incentives to be included in the offer.

Order 302 is received from a point of sales (POS) station 312 in location 132 or from a wireless communications device (WCD) associated with the customer. A WCD is discussed infra. Any POS station known in the art, for example, a cashier station or a self-service kiosk, can be used to transmit the order.

In a first embodiment, the memory unit stores transaction history 314 for the customer. The history tracks individual customer buying habits and/or tracks customer responses, including, accept rates or use of coupons and other suggestive selling or marketing offers. In one embodiment, the offer element identifies, using the interface element, the customer using any means known in the art, for example, by identifying a WCD used by the customer to transmit order 302 or by information obtained via the POS, such as a loyalty card. The offer element selects the transaction history and generates offer 306 using the transaction history, for example, identifying trends or preferences from the history that may be useful in generating a more acceptable offer 304. The discussion supra regarding element 142 and history 144 is applicable to the offer element and history 314.

In another embodiment, the offer element reviews the history to identify an item or service not included in the history (an presumably never ordered by the customer) or ordered by the customer at less than a predetermined frequency. Then, the offer element includes, in the at least one ideal order offer, the item or service not included in the history or ordered by the customer at less than a predetermined frequency.

In a second embodiment, the offer element evaluates order 302 to determine a number of other customers with the customer and generates offer 306 accordingly. For example, if order 302 includes three of a certain item, the offer element could surmise that there is a total of three customers in the customer's party and the number of items or services included in the offer is selected to reflect the number in the party. For example, in a fast serve restaurant, if order 302 includes three hamburgers and no dessert items, the offer element determines that there are three customers in the party and offer 306 includes three dessert items.

In a third embodiment, order 302 is received from a WCD associated with the customer, for example, WCD 316, via a wireless communications network, for example, network 318. In a fourth embodiment, offer 306 is transmitted to a WCD associated with the customer, for example, WCD 316, via a wireless communications network, for example, network 318. WCD 316 is connected to wireless communications network 318 with radio frequency connection 320. Network 318 is connected to computer 114 with hardwire connection 322. The discussion, in the description of FIG. 1, of WCD 118 and network 130 is applicable to WCD 316 and network 318, respectively.

In a fourth embodiment, computer 114 receives at least one modifying rule 324 from a WCD associated with the customer, for example, WCD 316 and stores the rule in memory 128. Element 302 modifies offer 304 using rule 324. The WCD generates rule 324 and element 302 modifies offer 304 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In a fifth embodiment, computer 326 transmits at least one modifying rule 328 to computer 114. Computer 114 stores modifying rule 328 in memory 128. Element 302 modifies offer 304 using rule 328. Computer 326 generates rule 328, and element 302 modifies offer 304 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment (not shown), multiple computers 326 are included and respective computers among the multiple computers can be associated with the same or different business entities. Computer 326 is connected to computer 114 by any means known in the art, for example, hardwire connection 330.

In a sixth embodiment, a WCD associated with the customer, for example, WCD 316, includes memory element 332 and processor 334. WCD 316 stores at least one rule 336 in the memory element and processor 334 executes offer 306 according to rule 336. The discussion, in the description of FIG. 1, of WCD 118 and rule 184 is applicable to WCD 316 and rule 336, respectively. For example, the WCD generates rule 336, and operates on offer 306 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment, artificial intelligence program 338 is stored in memory 332 and WCD 316 executes offer 306 using program 338. In another embodiment, WCD 316 executes offer 306 using program 338 and rule 336.

In a seventh embodiment, the offer element stores information 340 in the memory element regarding the historical acceptance of offers 306. That is, information 33 is a history of the acceptance of offers 306 made in the past. The offer element then modifies rules 308 according to information 340. In one embodiment, the offer element uses program 310 to modify rules 308. In another embodiment, the offer element uses artificial intelligence program 342, stored in the memory element, to modify the rules. For example, the offer element can increase the frequency, in offer 306, of items, services, or incentives that have higher acceptance rates according to information 338 and can link items, services, and incentives to other parameters, such as time of day, that have affected the acceptance of the items, services, or incentives according to information 340. Such learning/modification can make use of any or all customer or other information as it becomes available or as it is stored or accumulated over time with each successive transaction.

In a further embodiment, based upon the acceptance or rejection rates by a customer or customers of idea offers, such as offer 306, the system determines that a particular ideal offer is either desirable or undesirable. If found to be undesirable, e.g., due to a higher than average rejection rate, and/or based upon any other financial or statistical means, e.g., profit margins, gaming, dilution, fishing, diversion, speed of service, customer frequency, customer satisfaction survey or other results, e.g., via a voice survey, inventory control, corporate objectives, average check, average item counts, market basket analysis, labor rates, and/or any other measure or combination of the foregoing, system 300 can cease to offer such orders to the same or similar customers or to all customers.

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” regarding the modification of rules is applicable to the modification of rules 308 by the offer element.

It should be understood that various storage and removal operations, not explicitly described above, involving memory 128 and as known in the art, are possible with respect to the operation of system 300. For example, outputs from and inputs to the general-purpose computer can be stored and retrieved from the memory elements and data generated by the processor can be stored in and retrieved from the memory.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 300 can be integral with a computer operating system for a business location, for example, location 132 or with a business entity operating the business location. It also should be understood that system 300 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, programs 310 and 342 can be a single program (not shown).

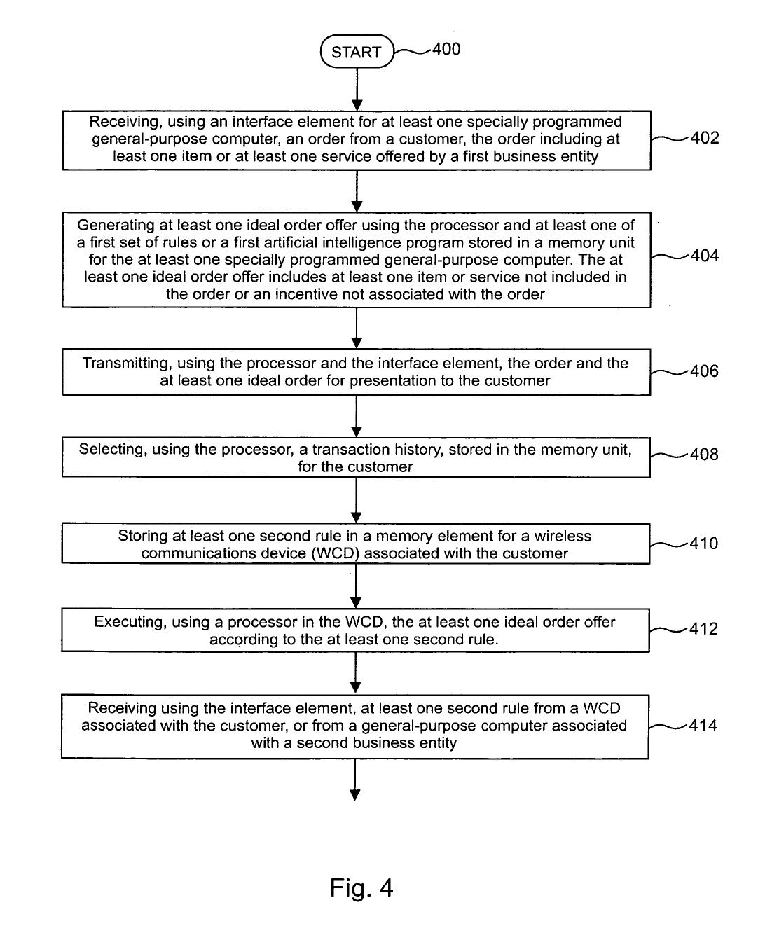

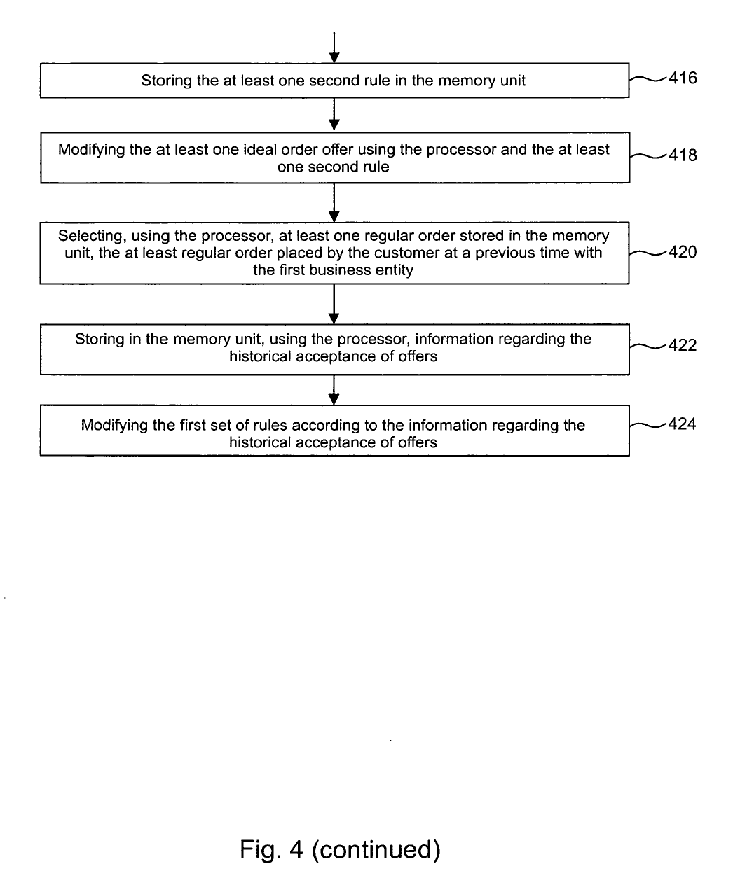

FIG. 4 is a flow chart illustrating a present invention computer-based method for method for generating and transmitting an ideal order offer. Although the method in FIG. 4 is depicted as a sequence of numbered steps for clarity, no order should be inferred from the numbering unless explicitly stated. The method starts at Step 400. Step 402 receives, using an interface element for at least one specially programmed general-purpose computer, an order from a customer, the order including at least one item or at least one service offered by a first business entity. Step 404 generates at least one ideal order offer using the processor and at least one of a first set of rules and a first artificial intelligence program stored in a memory unit for the at least one specially programmed general-purpose computer, the at least one ideal order offer including at least one item or service not included in the order or an incentive not associated with the order. Step 406 transmits, using the processor and the interface element, the order and the at least one ideal order for presentation to the customer. I

In a first embodiment, step 408 selects, using the processor, a transaction history, stored in the memory unit, for the customer and generating the at least one ideal order offer includes generating the at least one ideal order offer using the transaction history. In a second embodiment, using the transaction history includes identifying a first item or service not included in the history or identifying a second item or service ordered by the customer at less than a predetermined frequency and wherein generating the at least one ideal order offer comprises including, in the at least one ideal order offer, the first or second item or service.

In a third embodiment, using the transaction history includes identifying an incentive previously presented to the customer and generating the at least one ideal order offer includes: modifying the incentive or generating a new incentive different from the incentive; and including, in the at least one ideal order offer, the modified incentive or the new incentive. In a fourth embodiment, receiving an order includes receiving, via a wireless communications network, the order from a wireless communications device (WCD) associated with the customer and transmitting the at least one ideal order offer includes transmitting the at least one ideal order offer to the wireless communications network for transmission to the WCD.

In a fifth embodiment, step 410 stores at least one second rule in a memory element for a WCD associated with the customer, transmitting the at least one ideal order offer includes transmitting the at least one ideal order offer to a wireless communications network for transmission to the WCD and step 412 executes, using a processor in the WCD, the at least one ideal order offer according to the at least one second rule. In a sixth embodiment, step 414 receives, using the interface element, at least one second rule from a WCD associated with the customer, or from a general-purpose computer associated with a second business entity; step 416 stores the at least one second rule in the memory unit; and step 418 modifies the at least one ideal order offer using the processor and the at least one second rule and transmitting the at least one ideal offer includes transmitting the modified at least one ideal offer.

In a seventh embodiment, step 420 selects, using the processor, at least one regular order stored in the memory unit, the at least regular order placed by the customer at a previous time with the first business entity and generating the at least one ideal order offer includes using the at least one regular order. In an eighth embodiment, the order from the customer includes a request to initiate at least one regular order associated with the customer, the at least one regular order stored in the memory unit, generating the at least one ideal order offer includes using the at least one regular order, and transmitting the order and the at least one ideal order for presentation to the customer includes transmitting the at least one regular order.

In a ninth embodiment, step 422 stores in the memory unit, using the processor, information regarding the historical acceptance of offers and step 424 modifies the first set of rules according to the information regarding the historical acceptance of offers.

The following should be viewed in light of FIGS. 3 and 4. In one embodiment, marketing messages, content, offers, incentives, etc., are created and/or maintained centrally or in a distributed network, including, for example, locally. Such management can be accomplished via any applicable means available, including, for example, making use of existing, e.g., off the shelf and/or customized tools that provide for such creating, management and/or distribution.

In another embodiment, the present invention accesses certain information from existing systems, including, for example, existing POS databases, such as customer transaction data, price lists, inventory information and/or other in or above store, e.g., location data, including, but not limited to data in a POS, back office system, inventory system, revenue management system, loyalty or marketing program databases, labor management or scheduling systems, time clock data, production or other management systems, e.g., kitchen production or manufacturing systems, advertising creation and/or tracking databases, including click through data, impressions information, results data, corporate or store or location financial information, including, for example, profit and loss information, inventory data, performance metrics, e.g., speed of service data, customer survey information, digital signage information or data, and/or any other available information or data, and/or system settings data.

In a first embodiment, a present invention ideal order offer includes a discount. Such discounts can be associated and/or applied to specific items within the order, and/or to the entire order contents. For example, if the ideal order includes item A from a regular order and the addition of item B, the ideal order may include a discount, e.g., 10%, which discount may be applied and/or associated with each individual items within items A or B. Alternatively, the discount may be applied to all items, e.g., a 10% for all items if the customer buys items A and B, but the offer as displayed to the customer, might be 25% off item B, with the savings appearing to the customer to be only on item B, while, from an accounting standpoint, the system has actually reduced the price for all the items by 10%. In one embodiment, such discounts are determined based upon rules established by management of the system or marketing program and/or as established or modified from time to time by any authorized personnel, and/or may be initially established and/or modified using a learning system, e.g., a genetic algorithm. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount.

In a second embodiment, discounts are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what incentives, if any, are required given the known information. For example, if customer A never orders item 1 with item 2, the present invention could offer the customer an ideal order offer, for example, offer 306, made up of items 1 and 2 with a 10% discount. If the customer rejects such offer, the present invention could attempt the same or similar offer upon the next customer's order entry, but this time offer a larger discount, for a 20% discount. Once the present invention determines a customer's price point, and/or the customer becomes habituated to ordering the item or service added to the ideal order, the present invention can reduce or eliminate related incentives.

In a third embodiment, the present invention, having acquired data regarding customer price elasticity and other information, uses such information to determine other ideal order offers for the same or generally similar customers, e.g., other customers who purchase item 1 but do not typically purchase item 2. In one embodiment, using such logic, the present invention determines classifications of customers and leverage use of such information by providing ideal order offers that are also optimized from the location or location management perspective/objectives.

Ideal order offers can be delivered to customers via any applicable means, including, but not limited to, a POS station, such as a kiosk or customer facing display; or a WCD, such as, a cellular telephone, PDA, laptop or PC. In one embodiment, the ideal order offer includes a graphic representation of some or all of the items or services in the ideal order. In another embodiment, the ideal order offer display includes the original or full menu board price for an item and/or a discounted price for the item. Such discount might be conveyed as a percentage, e.g., 10% off, and/or using a dollar savings amount, e.g., $0.45 off the ideal order.

Customers can select an ideal order offer by any available means, including, for example, touching a screen with such one or more offers, touching a cell phone button, for example, touching a number that corresponds with one or more such offers, speaking a command, e.g., if ordering via a voice recognition system, or simply telling the cashier.

In the event that a customer accepts an ideal order offer, the present invention can continue with order processing as usual or the present invention can proceed to the end of the current ordering cycle. Such end point may or may not include any post order suggestive selling. In most cases, there will be no further attempts at suggestive selling, in the assumption that the ideal order includes all items and satisfies all business goals and/or already has optimized the results for a given transaction. Exceptions to this process include offers to make or convert or otherwise record the accepted ideal meal as the customer's regular order, for example, as stored in history 314, and/or other offers that may not necessarily affect or relate to the current order, for example, an offer to provide an incentive to the customer to provide data regarding other potential customers, as disclosed in a commonly-owned U.S. patent application titled: “SYSTEM AND METHOD FOR PROVIDING INCENTIVES TO AN END USER FOR REFERRING ANOTHER END USER,” inventors Otto et al., filed concurrently. In general, such subsequent offers are unrelated to the current ideal order offer as a goal of the present invention is to avoid annoying such customer with too many offers or unwanted offers.

In one embodiment, items, services, or incentives for an ideal order offer are determined or based upon any available information including, for example, one or more or any combination of any business objectives, and/or customer identification, customer information, customer objectives, and/or customer historic data such as buying habits, tendency to accept or reject any offers and/or similar offers, and/or based upon such acceptance with or without a discount, and/or the amount of or type of discount, willingness to accept specific items or classes of items, and/or whether or not such items are complementary to base order items, a usual, preferred, or last ordered items, general price elasticity as determined by prior ordering habits and/or those of similar customers, and/or classes of customers, or for a given store or location, and/or based upon the time of day, day of week, month, year, the weather, competitive information, such as information about current marketing campaigns, discounts, marketing offers, and like from one or more competitors,

In another embodiment, customers identify themselves using overt actions, e.g., by swiping a card. In a further embodiment, in addition or in the alternative to providing such identification means overtly, customers identify themselves passively, including, for example, by providing a cell phone number, GPS identification number or IP address, and/or a license plate number. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices;” and commonly-owned U.S. patent application Ser. No. 12/151,038, filed May 2, 2008 and entitled “Method and Apparatus for Generating and Transmitting an Order Initiation Offer to a Wireless Communications Device,” are applicable to customer identification. In yet another embodiment, the present invention uses such identification means to retrieve information about a customer, e.g., customer, business or sponsor information, which information is used to better or optimally determine if an offer or marketing message should be sent or otherwise provided to the customer.

In one embodiment, the present invention further determines which ideal order offers to make or to suppress based upon other performance data or results. In another embodiment, the present invention considers the impact of one or more offers on a customer's ability or proclivity to game or fish the system and avoids or ceases making offers and/or changes the type of offers generated and transmitted for a given customer or class of customers. For example, if a customer receives one offer to visit a given location at a given time, the system does not make another such offer if such customer accepts said offer, and/or the system does not make another such offer or other similar offer until a certain predefined or otherwise determined delay, e.g., one month. This technique is employed to help ensure that offers, if or when accepted, are generally accretive and are not dilutive to existing sales and profits.

In a further embodiment, the present invention improves results over time and/or with use of the present invention. Such improvement or optimization can be accomplished as described supra. For example, statistical methods can be used to determine which marketing messages, offers, incentives, content or other communications in an ideal order offer generally yield the desired or optimal or generally better results. Also such results can be determined using one or more genetic algorithms. Further, a present invention end user can review results reports and then provide manual weighting criteria to further define or control the present invention. As well, any combination of the foregoing can be employed in any combination and/or in any order or priority.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware: POS Controller

2. Software: Ideal Order generation program

The following is a listing of exemplary data bases that can be used in a present invention method or system. It should be understood that a present invention method or system is not limited to any or all of the databases shown and that other databases are included in the spirit and scope of the claimed invention.

1. Customer database including:

Customer ID

Transaction History

Regular Order 1−n

Ideal Order 1−n

2. Regular Order database including:

Item ID 1−n

Customer ID 1−n

3. Ideal Order database including:

Ideal Order ID

Regular Order ID

Ideal Order Item 1−n

4. Ideal Order rules and conditions database including:

Ideal Order Rule ID

Ideal Order Rule Descriptor

5. Transaction database including:

Transaction ID

Customer ID

Item ID 1−n

Ideal order ID 1−n

Ideal Order accepted?

Date/Time

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for generating and transmitting an ideal order offer, comprising the steps of:
receiving, using an interface element for at least one specially programmed general-purpose computer, an order from a customer, the order including at least one item or at least one service offered by a first business entity;
generating at least one ideal order offer using the processor and at least one of a first set of rules and a first artificial intelligence program stored in a memory unit for the at least one specially programmed general-purpose computer, the at least one ideal order offer including at least one item or service not included in the order; and,
transmitting, using the processor and the interface element, the order and the at least one ideal order offer for presentation to the customer.

2. The method of claim 1 further comprising the step of selecting, using the processor, a transaction history, stored in the memory unit, for the customer and wherein generating the at least one ideal order offer includes generating the at least one ideal order offer using the transaction history.

3. The method of claim 2 wherein using the transaction history includes identifying a first item or service not included in the history or identifying a second item or service ordered by the customer at less than a predetermined frequency and wherein generating the at least one ideal order offer comprises including, in the at least one ideal order offer, the first or second item or service.

4. The method of claim 2 wherein using the transaction history includes identifying an incentive previously presented to the customer and wherein generating the at least one ideal order offer includes: modifying the incentive or generating a new incentive different from the incentive; and including, in the at least one ideal order offer, the modified incentive or the new incentive.

5. The method of claim 1 further comprising the step of evaluating, using the processor, the order to determine a number of other customers with the customer and wherein the at least one item or service not included in the at least one regular order offer comprises a number of said at least one item or service, respectively, equal to the number of the other customers.

6. The method of claim 1 wherein receiving an order includes receiving, via a wireless communications network, the order from a wireless communications device (WCD) associated with the customer and wherein transmitting the at least one ideal order offer includes transmitting the at least one ideal order offer to the wireless communications network for transmission to the WCD.

7. The method of claim 1 further comprising the step of storing at least one second rule in a memory element for a WCD associated with the customer, wherein transmitting the at least one ideal order offer includes transmitting the at least one ideal order offer to a wireless communications network for transmission to the WCD, and the method further comprising the step of executing, using a processor in the WCD, the at least one ideal order offer according to the at least one second rule.

8. The method of claim 1 further comprising the steps of:
receiving, using the interface element, at least one second rule from a WCD associated with the customer, or from a general-purpose computer associated with a second business entity;
storing the at least one second rule in the memory unit; and,
modifying the at least one ideal order offer using the processor and the at least one second rule and wherein transmitting the at least one ideal offer includes transmitting the modified at least one ideal offer.

9. The method of claim 1 further comprising the step of selecting, using the processor, at least one regular order stored in the memory unit, the at least regular order placed by the customer at a previous time with the first business entity and wherein generating the at least one ideal order offer includes using the at least one regular order.

10. The method of claim 1 wherein the order from the customer includes a request to initiate at least one regular order associated with the customer, the at least one regular order stored in the memory unit, wherein generating the at least one ideal order offer includes using the at least one regular order, and wherein transmitting the order and the at least one ideal order for presentation to the customer includes transmitting the at least one regular order.

11. The method of claim 1 wherein generating at least one ideal order offer includes modifying the order to include the at least one item or service not included in the order or to include an incentive regarding the at least one item or at least one service offered by the first business entity and wherein transmitting the order and the at least one ideal order for presentation to the customer includes transmitting only the modified order to the customer.

12. The method of claim 1 including the steps of:
storing in the memory unit, using the processor, information regarding the historical acceptance of offers; and,
modifying, using the processor, the first set of rules according to the information regarding the historical acceptance of offers.

13. A system for generating and transmitting an ideal order offer, comprising:
an interface element for at least one specially programmed general-purpose computer;
a memory unit for the at least one specially programmed general-purpose computer; and,
an offer element, in a processor for the at least one specially programmed general-purpose computer for:
receiving, using the interface element, an order from a customer, the order including at least one item or at least one service offered by a first business entity;
generating at least one ideal order offer using at least one of a first set of rules and a first artificial intelligence program stored in a memory unit for the at least one specially programmed general-purpose computer, the at least one ideal order offer including at least one item or service not included in the order or an incentive not associated with the order; and,
transmitting, using the interface element, the order and the at least one ideal order offer for presentation to the customer.

14. The system of claim 13 wherein the offer element is for selecting a transaction history, stored in the memory unit, for the customer and wherein generating the at least one ideal order offer includes generating the at least one ideal order offer using the transaction history.

15. The system of claim 14 wherein using the transaction history includes identifying a first item or service not included in the history or identifying a second item or service ordered by the customer at less than a predetermined frequency and wherein generating the at least one ideal order offer comprises including, in the at least one ideal order offer, the first or second item or service.

16. The system of claim 14 wherein using the transaction history includes identifying an incentive previously presented to the customer and wherein generating the at least one ideal order offer includes: modifying the incentive or generating a new incentive different from the incentive; and including, in the at least one ideal order offer, the modified incentive or the new incentive.

17. The system of claim 13 wherein the offer element is for evaluating the order to determine a number of other customers with the customer and wherein the at least one item or service not included in the at least one regular order offer comprises a number of said at least one item or service, respectively, equal to the number of the other customers.

18. The system of claim 13 further comprising a wireless communications device (WCD) associated with the customer, wherein the offer element is for receiving, via a wireless communications network, the order from the WCD, and wherein transmitting the at least one ideal order offer includes transmitting the at least one ideal order offer to the wireless communications network for transmission to the WCD.

19. The system of claim 13 further comprising a WCD, associated with the customer, with a memory unit and a processor, the WCD for storing at least one second rule in a memory element for the WCD, wherein transmitting the at least one ideal order offer includes transmitting the at least one ideal order offer to a wireless communications network for transmission to the WCD, and wherein the processor in the WCD for executing the at least one ideal order offer according to the at least one second rule.

20. The system of claim 13 wherein the offer element is for:
receiving, using the interface element, at least one second rule from a WCD associated with the customer, or from a general-purpose computer associated with a second business entity;
storing the at least one second rule in the memory unit; and,
modifying the at least one ideal order offer using the at least one second rule and wherein transmitting the at least one ideal offer includes transmitting the modified at least one ideal offer.

21. The system of claim 13 wherein the offer element is for selecting at least one regular order stored in the memory unit, the at least regular order placed by the customer at a previous time with the first business entity and wherein generating the at least one ideal order offer includes using the at least one regular order.

22. The system of claim 13 wherein the order from the customer includes a request to initiate at least one regular order associated with the customer, the at least one regular order stored in the memory unit, wherein generating the at least one ideal order offer includes using the at least one regular order, and wherein transmitting the order and the at least one ideal order for presentation to the customer includes transmitting the at least one regular order.

23. The system of claim 13 wherein generating at least one ideal order offer includes modifying the order to include the at least one item or service not included in the order or to include an incentive regarding the at least one item or at least one service offered by the first business entity and wherein transmitting the order and the at least one ideal order for presentation to the customer includes transmitting only the modified order to the customer.

24. The system of claim 13 wherein the offer element is for:
storing in the memory unit, using the processor, information regarding the historical acceptance of offers; and,
modifying the first set of rules according to the information regarding the historical acceptance of offers.
